(19) United States
(12) Patent Application Publication
(10) Pub. No.: US 2025/0269938 A1
(43) Pub. Date: Aug. 28, 2025

(54) MASS AUGMENTATION OF A TENSION-LEG PLATFORM

(71) Applicant: Pelastar, LLC, Seattle, WA (US)

(72) Inventors: Ian William McCauley, Portland, OR (US); Benjamin Bailey Ackers, Seattle, WA (US); Reed Andrew Lillie, Coventry, RI (US)

(21) Appl. No.: 18/585,655

(22) Filed: Feb. 23, 2024

(51) Int. Cl. B63B 21/50; B63B 35/40; B63B 35/44; F03D 13/20; F03D 13/25

(52) U.S. Cl. CPC B63B 21/502; B63B 35/40; F03D 13/201; F03D 13/256; B63B 2035/446; F05B 2240/93

(57) ABSTRACT

Tension-leg platforms for supporting wind turbines are augmented with surge plates. The surge plates increase the amount of water that is displaced when a tension-leg platform is accelerated horizontally, which reduces wave induced accelerations. The surge plates are mounted to the deepest parts of the submerged structure of each platform to minimize wave loading.

### BACKGROUND

As the offshore wind industry moves into deeper water, designers have been searching for the most economical solution to support wind turbines on floating platforms. One solution, Tension-Leg Platforms (TLPs) shows promise in reducing the cost of floating offshore wind. TLPs have been used in the offshore Oil and Gas (O&G) industry since the 1980s and have particular traits which make them well suited to support wind turbines. However, TLPs have only recently started to receive the attention needed to optimize them for supporting wind turbines.

A TLP is an offshore structure comprising a hull with net buoyancy, secured to the seabed by pretensioned tendons. The tendons are secured to the seabed or the floor of any other body of water with anchors. The tendons attach to the platform at the tendon porch. The tension in the tendons counteracts the hull's net buoyancy, which stabilizes the hull. The required pretension in the tendons is determined by the design loads on the platform; primarily environmental loads from wind and waves. The larger the design loads, the higher the pretension must be to maintain the platform's stability.

For a certain combination of wind turbine and site conditions the wind loads on a TLP designed to support a wind turbine are nominally fixed. This means that if wave loads are ignored, the platform has baseline requirements for:
minimum tendon pretension: to withstand the overturning moments from the wind,
minimum structural capacity: to withstand the wind loads,
minimum buoyant volume: to provide the net buoyancy to float the mass of the platform, tower, and wind turbine, and achieve the minimum tendon pretension.

Loads from waves will increase these baseline limits because the wave loads will interact with the buoyant volume. The wave loads on the submerged body of the platform will increase platform motions which will reduce the stability and require a higher tendon pretension. Additionally, the increased motions will increase internal structural loads which will require the structure to be strengthened. A higher pretension requirement and higher structural mass will increase the required buoyant volume, which will attract more wave loads. If a designer does not take care to properly optimize a TLP to support a wind turbine it is easy to see how the introduction of wave loads could cause the design to spiral out of control.

TLPs for the O&G industry are designed to support massive topside drilling rigs, which results in platform designs that are very large and heavy. However, TLPs designed to support wind turbines can be over 10 times smaller and lighter due to the small tower footprint and comparatively light tower and turbine mass. This means that TLPs designed to support wind turbines will have a different dynamic response compared to O&G TLPs. However, while the dynamics are different, existing designs for TLPs supporting wind turbines generally follow the same design principles used on O&G TLPs. There is room to improve the designs of TLPs supporting wind turbines.

Per Newton's second law of motion, a floating structure will accelerate as a function of the magnitude of the applied wave force and the mass of the structure. With the accelerations of the structure being directly proportional to the internal structural loads, a primary goal of TLP designs is to minimize the wave induced accelerations. Minimizing the accelerations will result in lower internal loads enabling the design of lower cost platforms.

TLPs are typically designed to minimize accelerations by minimizing wave forces; attempting to be transparent to the waves. This is done by minimizing the water plane area and buoyant volume near the water surface. Wave particle velocities decay exponentially with water depth. The highest wave forces will therefore be generated near the surface of the water and decrease quickly with depth. By minimizing the amount of structure near the surface and moving the bulk of the structure deeper under the water, the total applied wave forces can be minimized.

TLP designs could also reduce accelerations by increasing platform mass. However, to maintain the required pretension the buoyant volume would need to be increased which would attract more wave loads and cancel out the reduction in accelerations from the increased mass. Consequently, TLPs designed to support wind turbines have focused solely on reducing wave loads and neglected to consider the potential benefits of augmenting the mass of the platforms. The purpose of this disclosure is to describe a method of augmenting the mass of TLPs designed to support wind turbines which helps to reduce the accelerations on the platforms and therefore lower the cost of existing platform designs.

### SUMMARY

The present disclosure can improve upon the basic design of a Tension-Leg platform by augmenting the mass of the platform in the horizontal direction. The present disclosure involves attaching surge plates to the submerged structure of a TLP to displace water when the platform accelerates horizontally, thereby increasing the horizontal added mass. It is envisioned that the surge plates will be thin flat plates oriented substantially vertical when the platform is upright and optimally located deep under water to increase the horizontal added mass of the platform while attracting minimal wave loading. The size and placement of the surge plates can be tuned to optimally augment the surge added mass.

Whereas it is typical to use the terms surge and sway to denote the fore-aft and side-side motions respectively of a ship, the directional terms are simplified here such that surge denotes any direction parallel to the still water.

In the field of fluid mechanics, added mass is defined as the mass of water surrounding a submerged body which is displaced (accelerated) when the body is accelerated relative to the surrounding water. When a submerged structure accelerates, it will displace the surrounding water such that the water moves out of the way in front of the structure, and fills in behind the structure. To accelerate a platform in surge, a unit force must act upon the effective horizontal mass of the platform, which is the sum of the mass of the platform plus the added mass of the displaced water. Consequently, by displacing more water, surge plates increase the effective horizontal mass of the platform which reduces horizontal accelerations, thereby reducing internal loads on the structure. By reducing internal loads in the platform, the structure can be built lighter and cheaper, resulting in a more cost-effective design.

The present disclosure benefits from the fact that added mass does not affect the pretension of the tendons. Tendon pretension is calculated in the static condition when neither the platform nor the surrounding water is accelerating. Without a relative acceleration between the platform and surrounding water the added mass is zero in all directions. Consequently, the added mass does not augment the static mass of the platform and pretension remains unaffected. Adding fixed mass to the platform, be it structural or ballast, would increase the weight of the platform and decrease the tendon pretension. This would require the buoyant volume of the platform to be increased to counteract the additional mass which would increase wave loads on the primary structure. However, since the added mass doesn't affect the static pretension, the buoyant volume remains unchanged and the wave loads on the primary structure remain unchanged. Therefore, surge plates provide a novel solution to reduce platform accelerations by increasing a TLP's effective horizontal mass without affecting buoyant volume or pretension.

It is unavoidable that the surge plates will attract additional wave loads that could counteract the reduction in accelerations provided by the increase in added mass. However, it is possible to minimize the additional wave loads by taking advantage of the exponential decay of wave particle velocities with respect to water depth. Just as existing TLPs are designed to minimize the amount of structure near the free surface by locating the bulk of the structure deeper underwater to minimize wave loading, this same design principle can be applied to surge plates. By attaching surge plates near, or even below, the base of the submerged structure the wave loads on the surge plates can be minimized. Consequently, when surge plates are properly positioned on a TLP deep under water, the increase in effective mass well exceeds the increase in wave loads, resulting in a net reduction in platform accelerations.

There are two main reasons that surge plates are not beneficial for an O&G TLP. First, O&G TLPs are already very heavy, meaning that there isn't a significant benefit to increasing the effective mass through added mass augmentation. Second, O&G platforms are concerned with limiting surge offset so that riser angles can be minimized. Risers are connected vertically between a platform down to the seabed. As a platform surges away from its static position it forces the riser to bend and take on an “S” shape. The bending introduces stresses which can cause the riser to fail. Horizontal loads on an O&G platform from ocean currents would be increased if surge plates were added, increasing the maximum surge offset and riser angle, which is not desirable. Surge plates provide a novel means to augment the added mass on TLPs designed to support a wind turbine, because they are significantly lighter than O&G TLPs and do not have a surge offset limitation.

The present disclosure includes a method of decreasing wave induced accelerations of a tension-leg platform by installing additional secondary structures (plates and/or panels) to form the surge plates.

The method includes increasing a mass of water displaced by the platform when the platform is accelerating horizontally by a system of one or more surge plates connected to a submerged structure of the platform, the surge plates including thin plates and/or panels, oriented to be substantially vertical when the platform is upright, whereby a submerged lateral projected area of the surge plates is greater than or equal to 10% of a lateral projected area of the submerged structure of the platform excluding the surge plates.

There is no requirement that the surge plates be constructed from any specific material(s), but could include materials such as metals, plastics, concrete, or a combination thereof. While these structures add to the mass and cost of the platform, these increases are offset by reductions in the mass and cost of the primary structure. By reducing the accelerations and resulting internal loads on the primary structure surge plates enable the design of TLPs which have lower mass and cost than the base designs without surge plates.

This summary is provided to introduce a concept in a simplified form that is further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a diagrammatical illustration of a tension-leg platform with surge plates, the illustration depicts the exponential decay of wave particle orbital velocities surrounding a TLP and the respective lateral projected areas of the platform and surge plates;

FIG. 2 is a diagrammatical illustration of two sections taken through the arms of TLPs depicted in FIGS. 3 and 4 showing surge plates attached to the structure of the arms and the increase in added mass of the arms due to the surge plates;

FIG. 3 is a diagrammatical illustration of a tension-leg platform with central column, five tubular truss arms, and surge plates mounted internal to the structural envelope within the arm trusses;

FIG. 4 is a diagrammatical illustration of a tension-leg platform with five down-sloping box arms, and a surge plate mounted external to the structural envelop on top of each arm;

FIG. 5 is a diagrammatical illustration of a tension-leg platform with a central column, five up-sloping box arms, and a surge plate mounted external to the structural envelope below each arm;

FIG. 6 is a diagrammatical illustration of a pyramidal shaped tension-leg platform with surge plates mounted external to the structural envelope to the bottom of the platform;

FIG. 7 is a diagrammatical illustration of a tension-leg platform with central column, 3 cylindrical arms, and surge plates mounted internal to the structural envelope, below the diagonal bracing;

FIG. 8 is a diagrammatical illustration of a tension-leg platform with a square base and surge plates mounted both internal and external to the structural envelope, above and below the base structure of the platform;

FIG. 9A is a diagrammatical illustration of a constant diameter central column;

FIG. 9B is a diagrammatical illustration of a variable diameter central column;

FIG. 10 is a diagrammatical illustration of a vertically oriented planar tubular truss arm with attached surge plates;

FIG. 11 is a diagrammatical illustration of a down-sloping box arm with tapered sides and a surge plate attached to the top of the arm;

FIG. 12 is a diagrammatical illustration of a down-sloping box arm with parallel sides and a surge plate attached to the top of the arm;

FIG. 13 is a diagrammatical illustration of an up-sloping box arm with tapered sides and a surge plate attached to the bottom of the arm with a keel plate attached along the bottom edge of the surge plate;

FIG. 14 is a diagrammatical illustration of an up-sloping box arm with parallel sides and a surge plate attached to the bottom of the arm with a keel plate attached along the bottom edge of the surge plate;

FIG. 15 is a diagrammatical illustration of an example of a porous surge plate;

FIG. 16A is a diagrammatical illustration of an example of a surge plate with no enclosed buoyant volume;

FIG. 16B is a diagrammatical cross-sectional illustration of the surge plate of FIG. 16A;

FIG. 17A is a diagrammatical illustration of an example of a surge plate with an enclosed buoyant volume; and

FIG. 17B is a diagrammatical cross-sectional illustration of the surge plate of FIG. 17A.

### DETAILED DESCRIPTION

When a submerged structure accelerates in a fluid, the surrounding fluid will be displaced such that it moves out of the way in front of the structure and fills in behind the structure. Because the fluid must be accelerated to be displaced, the total mass of the displaced fluid adds to the effective inertia of the submerged structure. In the field of fluid mechanics, the mass of the displaced fluid is known as added mass.

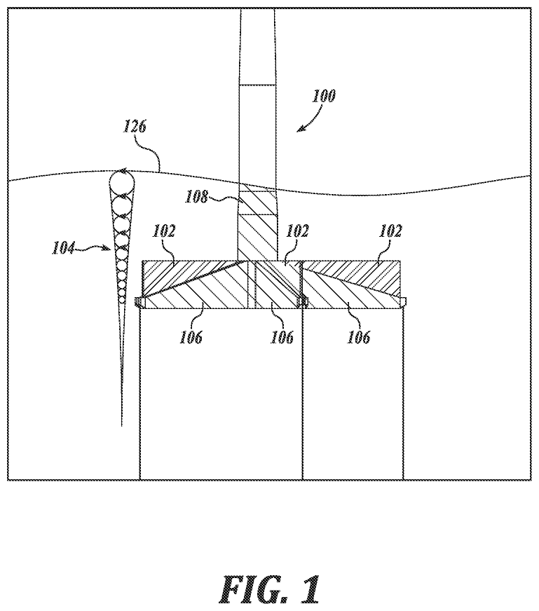

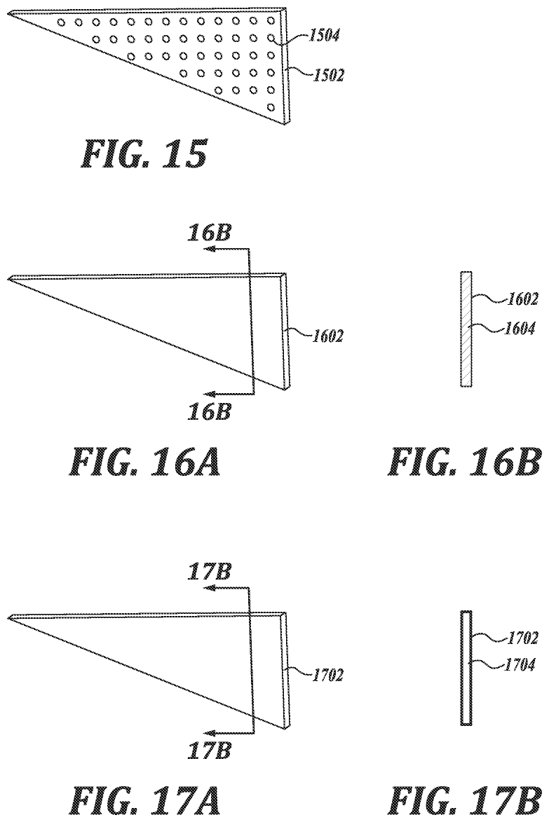

In one embodiment, surge plates are attached to a Tension-Leg Platform (TLP) designed to support offshore wind turbines. In one embodiment, the surge plates consist of thin plates and/or panels, oriented to be substantially vertical when the platform is upright, whereby the submerged lateral projected area of the surge plates is greater than or equal to 10% of the lateral projected area of the submerged structure of the platform excluding the surge plates. The surge plates may be configured to be open structures with no enclosed buoyant volumes or closed structures with enclosed buoyant volumes. FIGS. 16A and 16B illustrate an example of a surge plate 1602 with no enclosed buoyant volume, i.e., a solid interior 1604. FIGS. 17A and 17B illustrate an example of a surge plate 1702 with an enclosed buoyant volume 1704. The surge plates may also be configured to be nonporous allowing no water to pass through the surge plates or porous allowing some water to pass though openings in the surge plates. FIG. 15 is an example of a porous surge plate 1502 with holes 1504. Holes 1504 in the surge plates do not contribute to the lateral projected area of the surge plates. FIG. 1 depicts the above lateral projected areas of one embodiment of a TLP 100 with surge plates 102. Reference 104 of FIG. 1 depicts the exponential decay of wave particle orbital velocities surrounding a TLP and the respective lateral projected areas 108, 106 of the platform 100 and surge plates 102. “Lateral projected area” has the common ordinary meaning of being a two dimensional area of a three dimensional structure, when the three dimensional structure is projected onto any vertical plane. The submerged lateral projected area of the platform 100 visible in FIG. 1 including the arms 106, and the part of the column 108 that is under the surface of the water 126. is denoted by the single cross-hatching. The lateral projected area of the surge plates 102 visible in FIG. 1 is denoted by the double cross-hatching. Whereas it is typical to use the terms surge and sway to denote the fore-aft and side-side motions respectively of a ship, the directional terms are simplified here such that surge denotes any direction parallel to the still water (horizontal).

By increasing the lateral projected area of the submerged structure, the surge plates increase the amount of water that is displaced when the TLP is accelerating horizontally relative to the water. This increases the horizontal added mass of the TLP, thereby increasing the effective horizontal mass of the platform.

Whereas the displaced water is flowing freely around the submerged structure it is typical to represent the added mass as a fixed volume that moves with the structure.

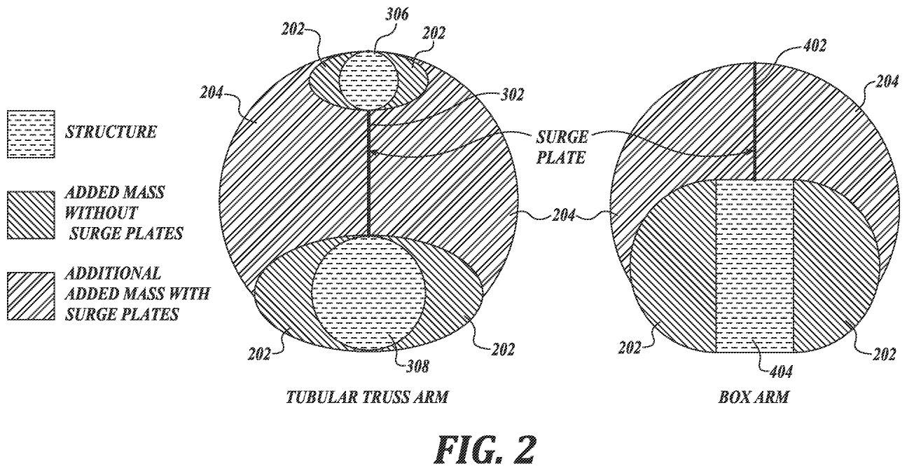

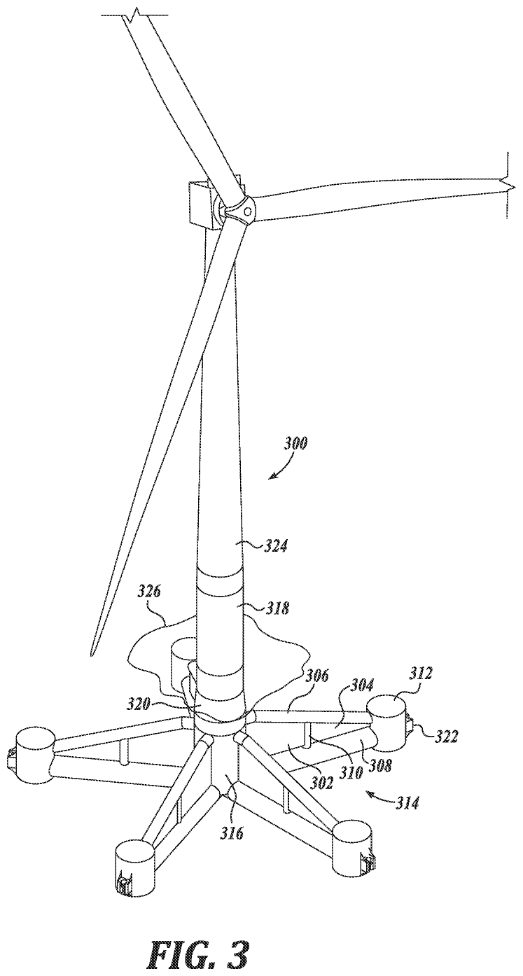

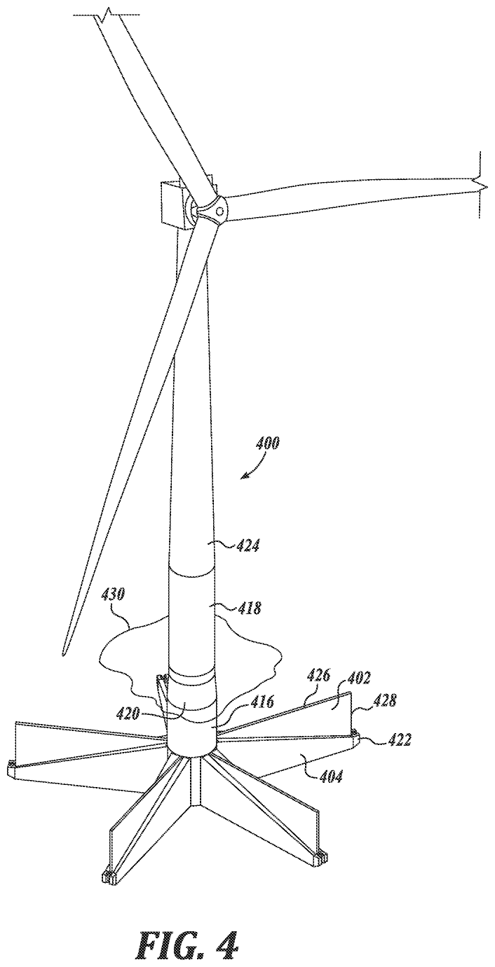

FIG. 2 shows a diagrammatical illustration of two section cuts through the arms of TLPs 300 and 400 illustrated in FIGS. 3 and 4. The areas filled with dashed lines in the diagram denote the primary structure of the arms 306, 308, and 404. The single hatching 202 denotes cross-sections of the horizontal added mass of water surrounding the primary arm structures that would be displaced by the arms if surge plates were not installed. The double hatching 204 denotes the additional added mass of water that would be displaced if surge plates 302, and 402 were installed.

In way of the section illustrated in FIG. 2 for the tubular truss arm 314 of FIG. 3, the surge plate 302 attached between the top and bottom chords 306, 308 increases the cumulative vertical length of the section by 72%, which approximately increases the total added mass of the section by 340%. In way of the section illustrated in FIG. 2 for the box arm 404, the surge plate 402 attached to the top of the arm increases the cumulative vertical length of the section by 68%, which approximately increases the total added mass of the section by 130%.

In one embodiment, the surge plates are attached to the lower half of the submerged structure of the TLP. TLPs are moored to the seabed with fixed length tendons meaning their draft varies with the tides. For the present disclosure, the submerged structure refers to the structure submerged at low astronomical tide. “Low Astronomical Tide” has the common ordinary meaning of the lowest predicted still water level due to combined tidal action of the sun and moon. As depicted in FIG. 1, wave particle orbital velocities 104 decrease exponentially with respect to water depth. By attaching the surge plates to the deepest parts of the submerged structure the particle velocities will be minimized; thereby minimizing the wave loads on the surge plates.

In one embodiment, the TLP to which the surge plates are attached comprises a central column with five arms extending radially from the base of the central column. It is to be understood that the particular TLP in the figures is for illustrating aspects of the disclosure which may be applicable to other types of TLPs. For example, FIGS. 3, 4, 5, 6, 7, and 8 illustrate TLPs which may be utilized in the present disclosure. Therefore, it is to be further understood that the disclosure can apply to any platform with positive net buoyancy that uses pretensioned tendons for anchoring the platform in or on a body of water.

FIG. 3 shows a diagrammatical illustration of one embodiment of a TLP 300 designed to support a wind turbine, with surge plates 302, 304 installed to increase the horizontal added mass of the platform. The TLP 300 takes the form of a central cylindrical column with five arms 314, equally spaced circumferentially around and extending radially from the base of the central column. The column is constructed of two cylinders 316, 318 of different diameters serially connected by a tapered conical section 320, the bottom most cylinder 316 having the larger diameter and the diameter of the upper cylinder 318 having the smaller diameter. Each arm 314 is arranged with a vertically oriented cylindrical buoyancy can 312 supported at a distance radially from the central column 316 by a vertically oriented planar truss. The top chord 306 and the bottom chord 308 of the truss are constructed from large-diameter cylindrical pipes, with each chord having a first end for connecting to the central column 316 and a second end for connecting to the buoyancy can 312. The chords 306, 308 are supported near their mid-spans by a single cylindrical vertical cylinder 312. At the distal end of each arm one or more tendon porches 322 are attached. Once the platform is installed, the base of the central column and arms are located a distance below the water surface 326. The central column extends a distance above the water surface 326 and supports the base of the wind turbine tower 324.

In one embodiment, two surge plates 302, 304 are attached to each arm 314 internal to the structural envelope, filling the open spaces inside each truss. The four sides of the inner surge plate 302 are attached to the side of the central column 316, the underside of the top chord 306, the top of the bottom chord 308 and the inside edge of the vertical cylinder 310 for each respective arm 314. The four sides of the outer surge plate 304 are attached to the underside of the top chord 306, the top of the bottom chord 308, the outside edge of the vertical cylinder 310 and the inside edge of the buoyancy can 310 for each respective arm. In one embodiment, the total lateral projected area of the surge plates 302, 304 is equal to 15.7% of the submerged lateral projected area of the platform (e.g., 306, 308, 310, 312, 316, 318, 320, 322) without surge plates. In alternate embodiments the total lateral projected area of the surge plates 302, 304 may be greater than or equal to 10% of the submerged lateral projected area of the platform (e.g., 306, 308, 310, 312, 316, 318, 320, 322) without surge plates. In one embodiment, the total lateral projected area of the two surge plates 302, 304 is equal to 53% of the lateral projected area of the arm 314 without the two surge plates. In alternate embodiments the total lateral projected area of one or more surge plates is greater than or equal to 25% of the lateral projected area of the arm 314 without the surge plate(s). In one embodiment, the lateral projected area of each surge plate 302, 304 is greater than or equal to 50% of the lateral projected area of the respective open area within the arm truss.

FIG. 4 shows a diagrammatical illustration of one embodiment of a TLP 400 designed to support a wind turbine, with surge plates 402 installed to increase the horizontal added mass of the platform. The TLP takes the form of a central cylindrical column with five arms 404, equally spaced circumferentially around and extending radially from the base of the central column. The column is constructed of two cylinders 416, 418 of different diameters serially connected by a tapered conical section 420, the bottom most cylinder 416 having the larger diameter and the diameter of the upper cylinder 418 having the smaller diameter. Each arm 404 includes a polyhedron approximately shaped like a truncated wedge. The outer surfaces of the arm 404 are constructed of flat panels. The bottom of the arm 404 is aligned with the bottom of the platform and parallel to baseline. The top of the arm 404 slopes down such that the tip of the arm 404 is shorter in height than the root of the arm 404. The sides of each arm 404 are angled inwards such that the tip of each arm 404 is narrower than its root. Once the platform is installed, the base of the central column and arms are located a distance below the water surface 430. The central column extends a distance above the water surface 430 and supports the base of the wind turbine tower 424.

In one embodiment, a single surge plate 402 is attached externally to the structural envelope, on top of each arm 404. Each surge plate 402 forms a triangle, with the hypotenuse attached to the top of the arm 404, the long edge 426 running parallel to baseline and the short edge 428 extending vertically upwards from the tendon porch 422. In one embodiment, the total lateral projected area of the surge plates 402 is equal to 17.3% of the submerged lateral projected area of the platform (e.g., 404.416, 418, 420, 422) without surge plates. In alternate embodiments, the total lateral projected area of the surge plates 402 is greater than or equal to 10% of the submerged lateral projected area of the platform (e.g., 404. 416, 418, 420, 422) without surge plates. In one embodiment, the lateral projected area of the surge plate 402 is equal to 60% of the lateral projected area of the arm 404 without surge plates. In alternate embodiments, the lateral projected area of the surge plate 402 is greater than or equal to 25% of the lateral projected area of the arm 404 without surge plates.

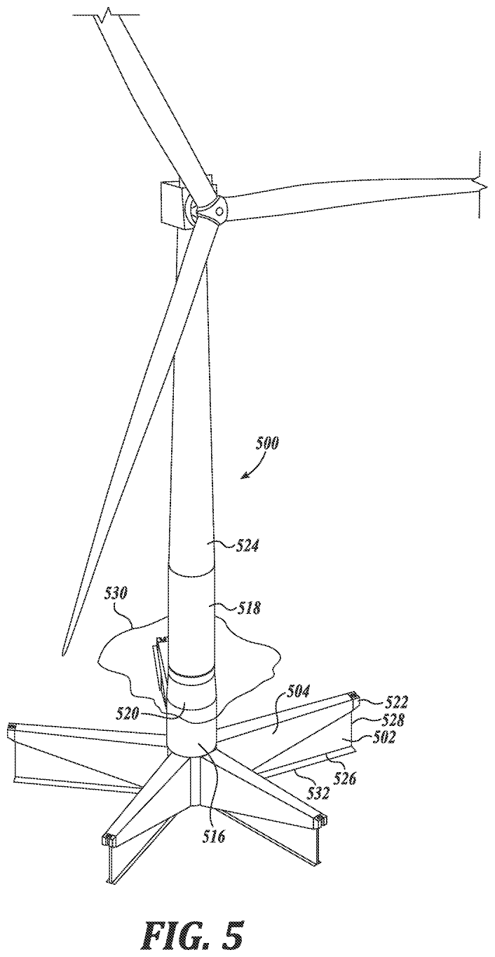

FIG. 5 shows a diagrammatical illustration of one embodiment of a TLP 500 designed to support a wind turbine, with surge plates 502 installed to increase the horizontal added mass of the platform. The TLP takes the form of a central cylindrical column with five arms 504, equally spaced circumferentially around and extending radially from the base of the central column. The column is constructed of two cylinders 516, 518 of different diameters serially connected by a tapered conical section 520, the bottom most cylinder 516 having the larger diameter and the diameter of the upper cylinder 518 having the smaller diameter. Each arm 504 includes a polyhedron approximately shaped like a truncated wedge. The outer surfaces of the arm 504 are constructed of flat panels. The top of the arm 504 is aligned parallel to the baseline of the platform at a distance above baseline. The bottom of the arm 504 slopes up from baseline such that the tip of the arm 504 is shorter in height than the root of the arm 504. The sides of each arm 504 are angled inwards such that the tip of each arm 504 is narrower than its root. Once the platform is installed, the base of the central column and arms are located a distance below the water surface 530. The central column extends a distance above the water surface 530 and supports the base of the wind turbine tower 524.

In one embodiment, a single surge plate 502 is attached externally to the structural envelope, to the bottom of each arm 504. Each surge plate 502 forms a triangle, with the hypotenuse attached to the bottom of the arm 504, the long edge 526 running parallel to baseline and the short edge 528 extending vertically downwards from the tendon porch 522. A keel plate 532 is attached to each surge plate 502 along the long edge 526 of the triangle. In one embodiment, the total lateral projected area of the surge plates 502 is equal to 17.3% of the submerged lateral projected area of the platform (e.g., 504, 516, 518, 520, 522) without surge plates. In alternate embodiments, the total lateral projected area of the surge plates 502 is greater than or equal to 10% of the submerged lateral projected area of the platform (e.g., 504, 516, 518, 520, 522) without surge plates. In one embodiment, the lateral projected area of the surge plate 502 is equal to 60% of the lateral projected area of the arm 504 without surge plates. In alternate embodiments, the lateral projected area of the surge plate 502 is greater than or equal to 25% of the lateral projected area of the arm 504 without surge plates.

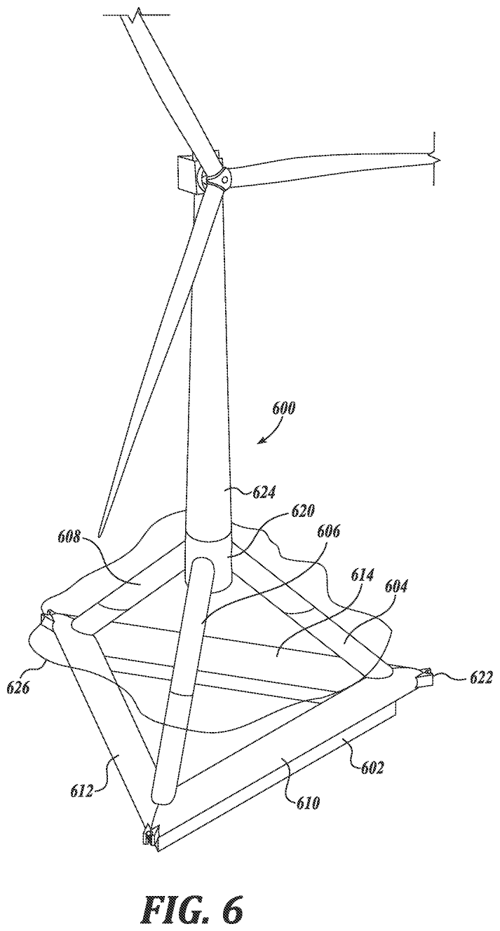

FIG. 6 shows a diagrammatical illustration of one embodiment of a TLP 600 designed to support a wind turbine, with surge plates 602 installed to increase the horizontal added mass of the platform. The TLP takes the form of a hollow tetrahedron; the six edges of the pyramid are formed from cylindrical members 604, 606, 608, 610, 612, and 614. The triangular base of the tetrahedron is formed from cylindrical members 610, 612, and 614. Cylindrical members 604, 606, and 608 form the edges of the tetrahedron which connect between the vertices of the base to the apex of the tetrahedron. One or more tendon porches 622 are attached at each vertex of the base of the pyramid. Once the platform is installed, the triangular base of the tetrahedron is located a distance below the surface of the water 626. The edges 604, 606, 608 of the tetrahedron converge at the apex, which is located a distance above the surface of the water 626. At the apex, the cylindrical members 604, 606, 608 converge into the central cylindrical transition piece 620 which supports the base of the wind turbine tower 624.

In one embodiment, surge plates 602 are attached to the external structural envelope of the TLP. The surge plates 602 are attached to the underside of the cylinders 610, 612, 614 forming the base of the pyramid. The surge plates 602 can extend the full length of the cylinders 610, 612, 614. In one embodiment, the total lateral projected area of the surge plates 602 is equal to 15.7% of the submerged lateral projected area of the platform (e.g., 604, 606, 608, 610, 612, 614) without surge plates. In alternate embodiments, the total lateral projected area of the surge plates 602 is greater than or equal to 10% of the submerged lateral projected area of the platform (e.g., 604, 606, 608, 610, 612, 614) without surge plates.

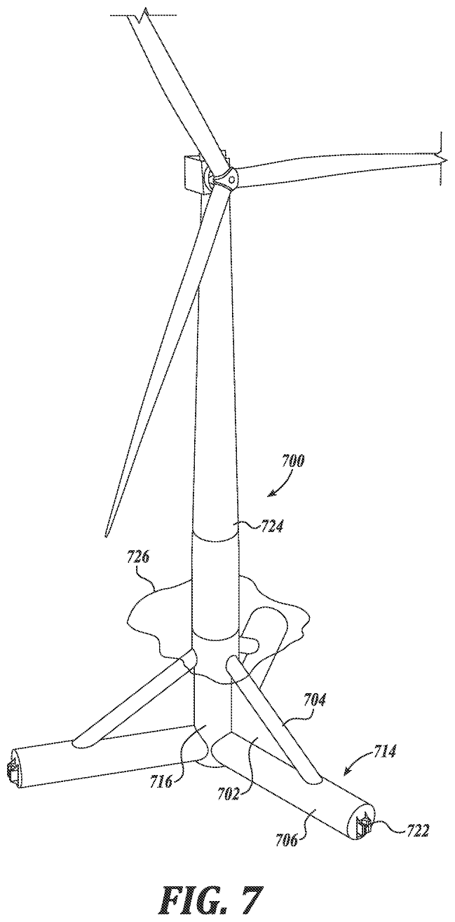

FIG. 7 shows a diagrammatical illustration of one embodiment of a TLP 700 designed to support a wind turbine, with surge plates 702 installed to increase the horizontal added mass of the platform. The TLP takes the form of a central constant diameter cylindrical column with three arms 714, equally spaced circumferentially around and extending radially from the base of the central column. Each of the arms 714 is formed from a single cylinder 706 and supported by a diagonal cylinder 704. The first end of each diagonal cylinder 704 connecting to each respective arm 714 near their mid span and a second end attached to the central column 716 a distance above the root of the respective arm 714. At the distal end of each arm 714 one or more tendon porches 722 are attached. Once the platform is installed, the base of the central column 716 and arms 714 are located a distance below the water surface 726. The central column 716 extends a distance above the water surface 726 and supports the base of the wind turbine tower 724.

In one embodiment a surge plate 702 is attached to each arm 714 within the structural envelope of the platform. The three sides of each surge plate 702 are attached to the side of the central column 716, the top of each respective arm cylinder 706, and the underside of each respective diagonal cylinder 704. In one embodiment, the total lateral projected area of the surge plates 702 is equal to 24.6% of the submerged lateral projected area of the platform (e.g., 704, 706, 716, 722) without surge plates. In alternate embodiments, the total lateral projected area of the surge plates 702 is greater than or equal to 10% of the submerged lateral projected area of the platform (e.g., 704, 706, 716, 722) without surge plates.

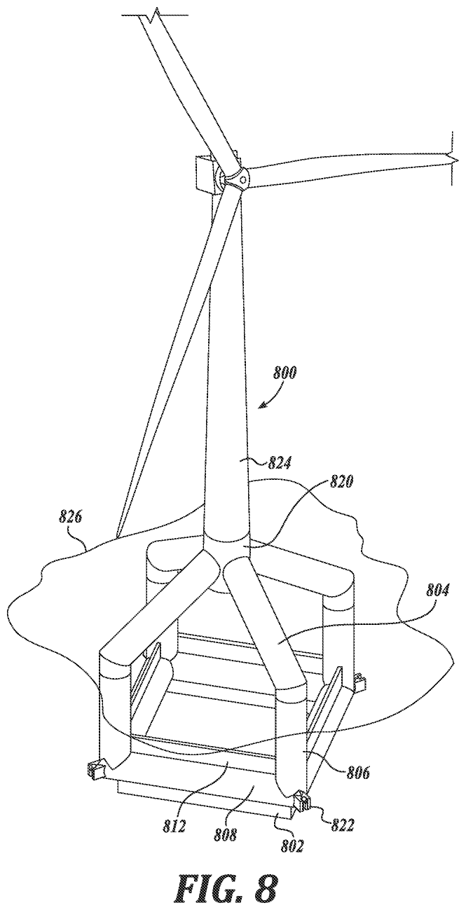

FIG. 8 shows a diagrammatical illustration of one embodiment of a TLP 800 designed to support a wind turbine, with surge plates 802 installed to increase the horizontal added mass of the platform. The TLP takes the form of a hollow prism shaped like a square pyramid stacked on top of a rectangular prism. The twelve edges of the structure are formed from cylindrical members. Four horizontal cylindrical members (e.g., 808) form the square base of the rectangular prism. The vertical edges of the rectangular prism are formed by four additional cylindrical members (e.g., 806). The remaining four cylindrical members (e.g., 804) form the edges of the square pyramid and connect the vertical edges (e.g., 806) of the rectangular prism to the apex of the square pyramid. One or more tendon porches 822 are attached at each vertex of the base of the structure. Once the platform is installed, the base of the structure is located a distance below the surface of the water 826. The vertical cylinders 806 extend up through the water surface 826. At the apex, the cylinders 804 converge into a central cylindrical transition piece 820 which supports the base of the wind turbine tower 824.

In one embodiment, surge plates 802, 812 are attached both internally and externally to the structural envelope of the platform. Surge plates 812 are attached internally to the tops of the cylinders 808 forming the square base of the structure and can extend from one vertical cylinder to another vertical cylinder. Surge plates 802 are attached externally to the underside of the cylinders 808 forming the square base of the structure and can extend the length of the cylinder. In one embodiment, the total lateral projected area of the surge plates is equal to 45.9% of the submerged lateral projected area of the platform (e.g., 806, 808) without surge plates. In alternate embodiments, the total lateral projected area of the surge plates is greater than or equal to 10% of the submerged lateral projected area of the platform (e.g., 806, 808) without surge plates.

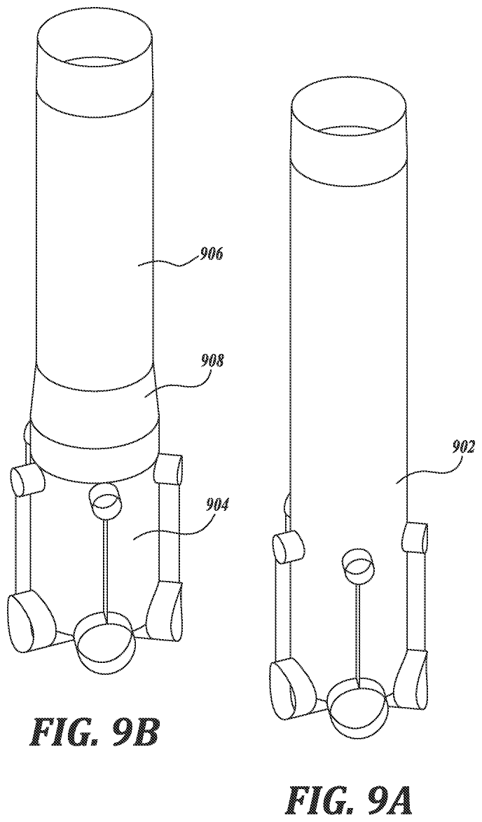

Multiple embodiments of a TLP comprising a central column with arms extending radially from the base of the central column with surge plates are depicted in FIGS. 3, 4 and 5. Additional variations on these embodiments are developed further in FIGS. 9-14.

FIGS. 9A and 9B depict two embodiments of the central column. FIG. 9A shows a diagrammatical illustration of one embodiment of a central column for a TLP designed to support a wind turbine, wherein the central column is constructed of a single constant diameter cylinder 902. FIG. 9B shows a diagrammatical illustration of one embodiment of a central column for a TLP designed to support a wind turbine, wherein the column is constructed of segmented cylinders 904, 906 of different diameters. The cylinders 904, 906 are serially connected by a tapered conical section 908. The bottom most cylinder 904 has the largest diameter and the diameters of the remaining cylinders 906 incrementally decrease with height.

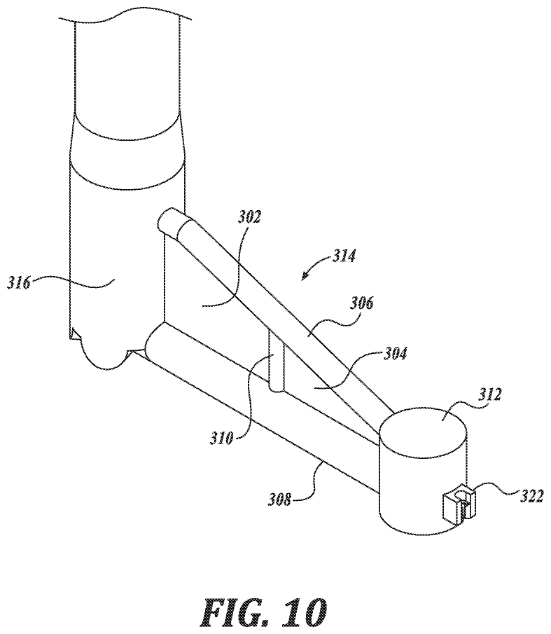

FIG. 10 shows a diagrammatical illustration of one embodiment of a tubular truss arm 314 for a TLP designed to support a wind turbine. The arm 314 is arranged with a vertically oriented cylindrical buoyancy can 312 supported at a distance radially from the central column 316 by a vertically oriented planar truss. The top chord 306 and the bottom chord 308 of the truss are constructed from large-diameter cylindrical pipes, with each chord having a first end for connecting to the central column 316 and a second end for connecting to the buoyancy can 312. The chords 306 and 308 are supported near their mid-spans by a single cylindrical vertical cylinder 310. At the distal end of each arm 314 one or more tendon porches 322 are attached. Two surge plates 302, 304 are attached to the arm 314 internal to the structural envelope, filling the open spaces inside the arm truss 314. The four sides of the inner surge plate 302 are attached to the side of the central column 316, the underside of the top chord 306, the top of the bottom chord 308 and the inside edge of the vertical cylinder 310. The four sides of the outer surge plate 304 are attached to the underside of the top chord 306, the top of the bottom chord 308, the outside edge of the vertical cylinder 310 and the inside edge of the buoyancy can 312. In one embodiment, the total lateral projected area of the two surge plates 302, 304 is equal to 53% of the lateral projected area of the arm 314 without the two surge plates. In alternate embodiments, the total lateral projected area of the two surge plates 302, 304 is greater than or equal to 40% of the lateral projected area of the arm 314 without the two surge plates. In one embodiment, the lateral projected area of each surge plate 302, 304 is greater than or equal to 90% of the lateral projected area of the respective open area within the arm truss.

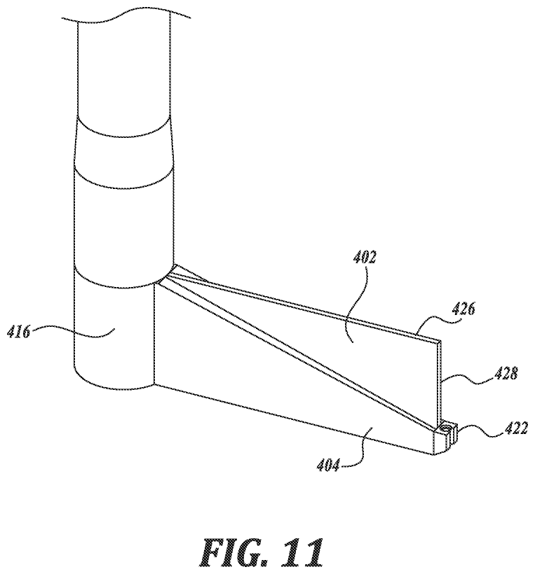

FIG. 11 shows a diagrammatical illustration of one embodiment of a box arm 404 for a TLP designed to support a wind turbine. The arm 404 includes a polyhedron approximately shaped like a truncated wedge. The outer surfaces of the arm 404 are constructed of flat panels. The bottom of the arm 404 is aligned with the bottom of the platform and parallel to baseline. The top of the arm 404 slopes down such that the tip of the arm 404 is shorter in height than the root of the arm 404. The sides of the arm 404 are angled inwards such that the tip of the arm 404 is narrower than its root. In one embodiment a single surge plate 402 is attached externally to the structural envelope, to the top of the arm 404. The surge plate 402 forms a triangle, with the hypotenuse attached to the top of the arm 404, the long side 426 running parallel to baseline and the short side 428 extending vertically upwards from the tendon porch 422. In one embodiment, the lateral projected area of the surge plate 402 is equal to 60% of the lateral projected area of the arm 404 without surge plates.

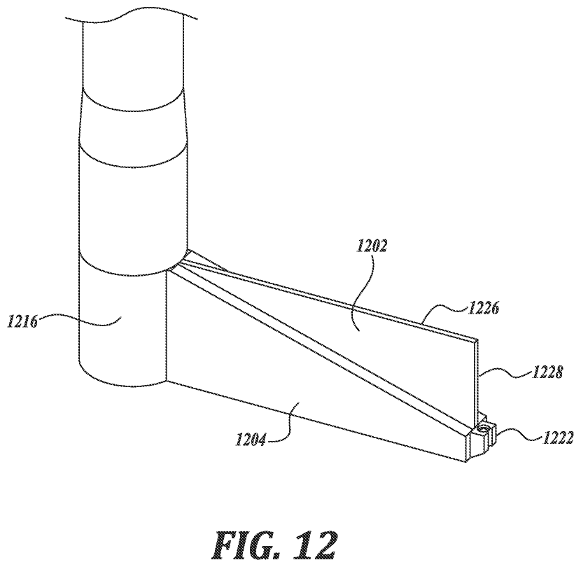

FIG. 12 shows a diagrammatical illustration of one embodiment of a box arm 1204 for a TLP designed to support a wind turbine. The arm 1204 includes a polyhedron approximately shaped like a truncated wedge. The outer surfaces of the arm 1204 are constructed of flat panels. The bottom of the arm 1204 is aligned with the bottom of the platform and parallel to baseline. The top of the arm 1204 slopes down such that the tip of the arm is shorter in height than the root of the arm. The sides of the arm 1204 are parallel such that the tip of the arm is the same width as its root. In one embodiment, a single surge plate 1202 is attached externally to the structural envelope, to the top of the arm 1204. The surge plate 1202 forms a triangle, with the hypotenuse attached to the top of the arm 1204, the long side 1226 running parallel to baseline and the short side 1228 extending vertically upwards from the tendon porch 1222. In one embodiment, the lateral projected area of the surge plate 1202 is equal to 60% of the lateral projected area of the arm 1204 without surge plates. In alternate embodiments, the lateral projected area of the surge plate 1202 is greater than or equal to 25% of the lateral projected area of the arm 1204 without surge plates.

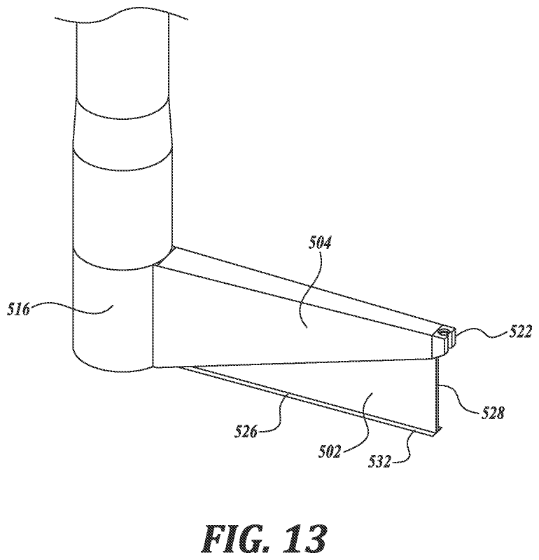

FIG. 13 shows a diagrammatical illustration of one embodiment of a box arm 504 for a TLP designed to support a wind turbine. The arm 504 includes a polyhedron approximately shaped like a truncated wedge. The outer surfaces of the arm 504 are constructed of flat panels. The top of the arm 504 is parallel to and located a distance above baseline. The bottom of the arm 504 slopes up from baseline such that the tip of the arm 504 is shorter in height than the root of the arm 504. The sides of the arm 504 are angled inwards such that the tip of the arm 504 is narrower than its root. In one embodiment a single surge plate 502 is attached externally to the structural envelope, to the bottom of the arm 504. The surge plate 502 forms a triangle, with the hypotenuse attached to the bottom of the arm 504, the long side 526 running parallel to baseline and the short side 528 extending vertically downwards from the tendon porch 522. In one embodiment a keel plate 532 is attached to support the long side 526 of the surge plate 502 along baseline. In one embodiment, the lateral projected area of the surge plate 502 is equal to 60% of the lateral projected area of the arm 504 without surge plates. In alternate embodiments, the lateral projected area of the surge plate 502 is greater than or equal to 25% of the lateral projected area of the arm 504 without surge plates.

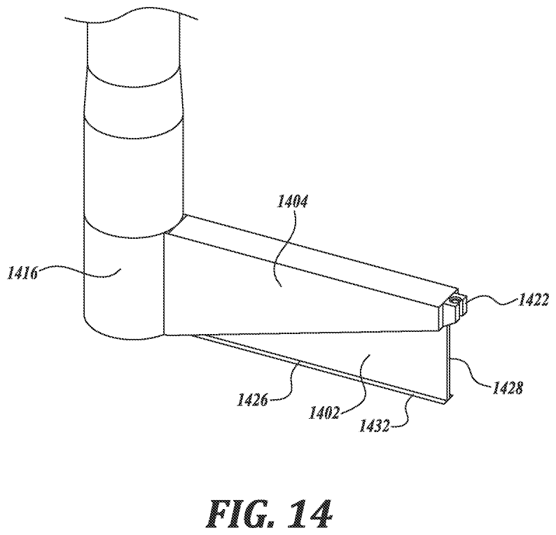

FIG. 14 shows a diagrammatical illustration of one embodiment of a box arm 1404 for a TLP designed to support a wind turbine. The arm 1404 forms a polyhedron approximately shaped like a truncated wedge. The outer surfaces of the arm 1404 are constructed of flat panels. The top of the arm 1404 is parallel to and located a distance above baseline. The bottom of the arm 1404 slopes up from baseline such that the tip of the arm is shorter in height than the root of the arm. The sides of the arm 1404 are parallel such that the tip of the arm is the same width as its root. In one embodiment, a single surge 1402 plate is attached externally to the structural envelope, to the bottom of the arm 1404. The surge plate 1402 forms a triangle, with the hypotenuse attached to the bottom of the arm 1404, the long side 1426 running parallel to baseline and the short side 1428 extending vertically downwards from the tendon porch 1422. In one embodiment a keel plate 1430 is attached to support the long side 1426 of the surge plate 1402 along baseline. In one embodiment, the lateral projected area of the surge plate 1402 is equal to 60% of the lateral projected area of the arm 1404 without surge plates. In alternate embodiments, the lateral projected area of the surge plate 1402 is greater than or equal to 25% of the lateral projected area of the arm 1404 without surge plates.

The embodiments of the disclosure in which an exclusive property or privilege is claimed are defined as follows:

1. A method of decreasing wave induced accelerations of a tension-leg platform having three or more tendons, the method comprising:
increasing a mass of water displaced by the platform when the platform is accelerating horizontally by a system of one or more surge plates connected to a submerged structure of the platform, the surge plates including thin plates and/or panels, oriented to be substantially vertical when the platform is upright, whereby a submerged lateral projected area of the surge plates is greater than or equal to 10% of a lateral projected area of the submerged structure of the platform excluding the surge plates.

2. The method of claim 1, wherein the surge plates are attached to a lower half of the submerged structure of the installed platform when measured at low astronomical tide.

3. The method of claim 1, wherein at least one surge plate is configured to be an open structure, with no enclosed buoyant volumes.

4. The method of claim 1, wherein at least one surge plate is configured to be a closed structure, with enclosed buoyant volumes.

5. The method of claim 1, wherein one or more sides of at least one surge plate is rigidly attached external to a structural envelope of the tension-leg platform.

6. The method of claim 1, wherein one or more sides of at least one surge plate is rigidly attached within a structural envelope of the tension-leg platform.

7. The method of claim 1, wherein one or more sides of a surge plate is rigidly attached to a structural member which extends radially from a central column and supports a tendon at its distal end, the lateral projected area of the surge plate is greater than or equal to 25% of the lateral projected area of the radial structural member excluding the surge plate.

8. A system of one or more surge plates attached to a structure of a tension-leg platform, the surge plates comprising thin plates and/or panels, oriented to be substantially vertical when the platform is upright, whereby a submerged lateral projected area of the one or more surge plates is greater than or equal to 10% of a lateral projected area of a submerged structure of the platform excluding surge plates.

9. The system of claim 8, wherein the surge plates are attached to a lower half of the submerged structure of the installed platform when measured at low astronomical tide.

10. The system of claim 8, wherein at least one surge plate is configured to be an open structure, with no enclosed buoyant volumes.

11. The system of claim 8, wherein at least one surge plate is configured to be a closed structure, with enclosed buoyant volumes.

12. The system of claim 8, wherein one or more sides of at least one surge plate is rigidly attached external to a structural envelope of the tension-leg platform.

13. The system of claim 8, wherein one or more sides of at least one surge plate is rigidly attached within a structural envelope of the tension-leg platform.

14. A floating, tension-leg wind turbine platform comprising:
a central cylindrical column;
three or more arms, equally spaced circumferentially around and extending radially from a base of the central column,
for each arm, one or more tendon porches located at a distal end of each arm for attaching one or more tendons;
for each arm one or more surge plates including thin plates and/or panels oriented to be substantially vertical when the platform is upright and rigidly attached to each arm, a sum total of a lateral projected area of the surge plates of each arm is greater than or equal to 25% of a lateral projected area of the arm excluding the surge plates;
a wind turbine tower attached to the top of the central column such that the long axis of the tower is parallel to the long axis of the central column.

15. The floating wind turbine platform of claim 14, wherein the central column is constructed of a single constant diameter cylinder.

16. The floating wind turbine platform of claim 14, wherein the column is constructed of segmented cylinders of different diameters serially connected together by tapered conical sections, a bottom most cylinder having a largest diameter and diameters of remaining cylinders incrementally decreasing with height.

17. The floating wind turbine platform of 15 or claim 16, wherein each arm is arranged with a vertically oriented cylindrical buoyancy can supported at a distance radially from the central column by a vertically oriented planar truss, the top and bottom chords of the truss constructed from large-diameter cylinders, each chord having a first end for connecting to the central column and a second end for connecting to the buoyancy can, the chords supported near their mid-spans by a single cylindrical vertical cylinder; and
each one of the surge plates is attached to the central column or respective buoyancy can, and respective truss members, filling at minimum 50% of an open area within each respective arm truss.

18. The floating wind turbine platform of claim 15 or claim 16, wherein each arm forms a polyhedron approximately shaped like a truncated wedge with outer surfaces formed by flat panels, a bottom of the arm aligned with a bottom of the platform and parallel to baseline, a top of the arm sloping down such that a tip of the arm is shorter in height than a root of the arm; and
a surge plate is attached to the top of the arm, the lateral projected area of the surge plate is greater than or equal to 25% of the lateral projected area of the arm excluding the surge plate.

19. The floating wind turbine platform of claim 15 or claim 16, wherein each arm forms a polyhedron approximately shaped like a truncated wedge with its outer surfaces formed by flat panels, the top of the arm aligned parallel to and at a distance above the baseline of the platform, the bottom sloping up from baseline such that a tip of the arm is shorter in height than the root of the arm; and
a surge plate is attached to the bottom of the arm, the lateral projected area of the surge plate is greater than or equal to 25% of the lateral projected area of the arm excluding the surge plate.

20. The floating wind turbine platform of claim 18, wherein sides of the arms are angled inwards such that the tip of each arm is narrower than the root.

21. The floating wind turbine platform of claim 19, wherein sides of the arms are angled inwards such that the tip of each arm is narrower than the root.

22. The floating wind turbine platform of claim 18, wherein sides of the arms are parallel such that the tip of each arm is the same width as the root.

23. The floating wind turbine platform of claim 19, wherein sides of the arms are parallel such that the tip each arm is the same width as the root.
